(19) United States
(12) Patent Application Publication
(10) Pub. No.: US 2007/0145266 A1
(43) Pub. Date: Jun. 28, 2007

(54) Electron microscope apparatus using CRT-type optics

(76) Inventors: Avi Cohen, Los Altos, CA (US); David L. Adler, San Jose, CA (US); Neil Richardson, Palo Alto, CA (US)

Correspondence Address: OKAMOTO & BENEDICTO LLP, P.O. BOX 641330, SAN JOSE, CA, 95164, US

(21) Appl. No.: 11/450,757

(22) Filed: Jun. 9, 2006

Related U.S. Application Data
(60) Provisional application No. 60/772,447, filed on Feb. 10, 2006.
(60) Provisional application No. 60/749,868, filed on Dec. 12, 2005.

(51) Int. Cl. G21K 7/00

(52) U.S. Cl. 250/310

(57) ABSTRACT

One embodiment relates to an apparatus which utilizes an electron beam for inspection or metrology of a substrate. The apparatus includes a CRT-type gun and deflectors to generate and scan the electron beam. The CRT-type gun may optionally be in a sealed vacuum. Another embodiment relates to a method of inspecting a substrate or measuring an aspect of the substrate. The method includes focusing an electron beam using electrostatic lenses formed by metal plates supported by and separated by fused glass beads or other insulating material. Other embodiments and features are also disclosed.

### CROSS-REFERENCE TO RELATED APPLICATION

The present application claims the benefit of U.S. Provisional Patent Application No. 60/772,447, entitled “Electron Microscope Apparatus Using CRT-Type Optics,” filed Feb. 10, 2006, by inventors Avi Cohen, David L. Adler and Neil Richardson, the disclosure of which is hereby incorporated by reference. The present application also claims the benefit of U.S. Provisional Patent Application No. 60/749,868, entitled “Electron Microscope Apparatus Using CRT-Like Optics,” filed Dec. 12, 2005, by inventors Avi Cohen, David L. Adler and Neil Richardson, the disclosure of which is hereby incorporated by reference. The present application is related to U.S. patent application Ser. No. 11/031,091, entitled “High-Speed Electron Beam Inspection,” filed Jan. 6, 2005, by inventors David L. Adler, et al., the disclosure of which is also hereby incorporated by reference.

### BACKGROUND OF THE INVENTION

1. Field of the Invention

The present disclosure relates to scanning electron microscopes, automated electron beam (e-beam) inspection, review and metrology equipment, and the like.

2. Description of the Background Art

Inspection, review and metrology tools are used during the semiconductor manufacturing process to increase and maintain integrated circuit yields. Conventional inspection, review, and metrology tools are typically large apparatus which may weigh several hundred pounds or more. These tools are typically implemented to use an x-y stage in order to position a region of interest of the sample under the beam. In some implementations of inspection tools, time-delay-integration (TDI) detectors may be used so that the substrate may be continuously moved under the beam.

The conventional technique for positioning a region of interest has disadvantages relating to cost, complexity and reliability of the moving stage. In addition, the conventional technique may have a relatively slow throughput rate for scanning wafers due to the need to reposition (or continuously move) the wafer under the beam.

The large bulk of the conventional apparatus makes it costly to manufacture and also limits its practical applications. For example, the large bulk of the stage makes it difficult to integrate the inspector into another semiconductor equipment tool for in-situ metrology applications.

It is desirable to improve electron beam apparatus inspection equipment and techniques. It is particularly desirable to reduce the cost to manufacture e-beam apparatus and to increase the applicability and speed of such apparatus.

### SUMMARY

One embodiment relates to an apparatus which utilizes an electron beam for inspection or metrology of a substrate. The apparatus includes a CRT-type gun and deflectors to generate and scan the electron beam. The CRT-type gun may optionally be in a sealed vacuum.

Another embodiment relates to an apparatus including a vacuum chamber with a base plate, a support structure connected to the base plate, and a column with an electron source and a series of electron lenses. The column is mechanically supported by a top portion thereof connected to the support structure. The series of electron lenses may comprise metal plates mechanically supported by and separated by fused glass beads or other insulating material.

Another embodiment relates to a method of inspecting a substrate or measuring an aspect of the substrate. The method includes focusing an electron beam using electrostatic lenses formed by metal plates supported by and separated by fused glass beads or other insulating material.

Another embodiment relates to a method of manufacturing an electron beam column for an electron microscope. The method uses insulative material to separate a series of metal plates by fixed distances.

Another embodiment relates to a scanning electron microscope apparatus having a gun lens assembly, wherein the gun lens assembly comprises at least three separate metal plates forming the gun lens and at least two insulators fixing the positions of the metal plates with respect to each other, whereby each of the insulators is fixing the position of each of the metal plates.

Other embodiments and features are also disclosed.

### BRIEF DESCRIPTION OF THE DRAWINGS

FIG. 1 is a schematic diagram of a high-speed two-dimensional scanning apparatus for automated electron beam inspection in accordance with an embodiment of the invention.

FIG. 2 is a schematic diagram of a first high-speed one-dimensional scanning apparatus for use with a one-dimensional moving stage in accordance with an embodiment of the invention.

FIG. 3 is a schematic diagram of a second high-speed one-dimensional scanning apparatus for use with a one-dimensional moving stage in accordance with an embodiment of the invention.

FIG. 4 is a schematic diagram of a high-speed swath scan of a wafer using a spiral path in accordance with an embodiment of the invention.

FIG. 5A is a schematic diagram of a low-vibration two-dimensional scanning apparatus in accordance with an embodiment of the invention.

FIG. 5B is a schematic diagram of a low-vibration two-dimensional scanning apparatus in accordance with another embodiment of the invention.

FIG. 6 is a top-view diagram of a support piece of the low-vibration two-dimensional scanning apparatus in accordance with an embodiment of the invention.

FIG. 7 is a schematic diagram of a CRT-type e-beam column in accordance with an embodiment of the invention.

FIG. 8 is a top-view diagram of a conductive plate within the CRT-type e-beam column in accordance with an embodiment of the invention.

FIG. 9A is a schematic diagram of a portable SEM system with a wired data interface in accordance with an embodiment of the invention.

FIG. 9B is a schematic diagram of a portable SEM system with a wireless data interface in accordance with an embodiment of the invention.

FIG. 10A is a schematic diagram of a portable SEM device with a rapid access specimen holder in accordance with an embodiment of the invention.

FIG. 10B is a schematic diagram of a portable SEM device with an environmental interface in accordance with an embodiment of the invention.

These drawings are used to facilitate the explanation of embodiments of the present invention. The drawings are not necessarily to scale.

### DETAILED DESCRIPTION

Electron Microscope Apparatus Using CRT-Type Optics

Traditional optical methods are available for macro wafer inspection, but these optical methods are not sensitive to electrical properties. Electron beam (e-beam) inspection tools are available, but these tools are currently too slow to be practical for wafer-level mapping on the order of several to tens of wafers per hour. Furthermore, vibrations in conventional e-beam inspection tools causes degradation of image resolution.

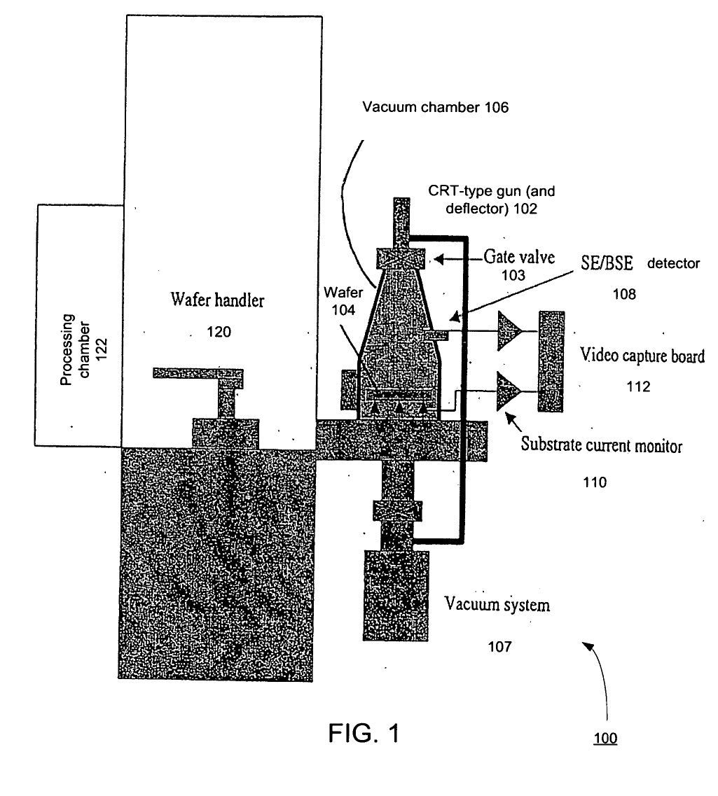

FIG. 1 is a schematic diagram of a high-speed two-dimensional scanning apparatus 100 for automated electron beam inspection in accordance with an embodiment of the invention. The two-dimensional scanning apparatus 100 is configured to advantageously utilize a cathode ray tube (CRT)-type gun (and deflection) 102 technology. The two-dimensional scanning apparatus 100 may be called a “macro” e-beam inspector with CRT-type optics.

In one embodiment, a wafer handler 120 may retrieve the wafer from a processing chamber 122 and transport the wafer to the scanning apparatus 100. The wafer may be pre-aligned and loaded into the vacuum chamber 106 (shown pumped by the vacuum system 107) and positioned under the CRT-type gun 102 of the scanning apparatus. In an alternate embodiment, the scanning apparatus 100 may be integrated into a processing chamber such that a separate loading step is not required to scan the wafer.

In one embodiment, a gate valve 103 may also be used, as shown in FIG. 1, to keep the CRT-type gun under vacuum (pumped by the vacuum system 107) while the wafer is loaded into the vacuum chamber 106. In another embodiment, the CRT-type gun may be permanently sealed and have an electron-beam-transparent window through which the electron beam is transmitted to the chamber 106.

The e-beam may then be scanned in two dimensions over the entire wafer and a two-dimensional image constructed. For example, the two-dimensional scanning may use a raster scan pattern or other pattern. The scan pattern to be used may be programmed into a controller that controls the deflection of the beam from the CRT-type gun 102. The deflection may be performed by controlling electrical currents going through electromagnetic coils attached to the CRT-type gun 102.

In one particular application, the inspector may be configured to scan over an entire wafer 104 (for example, a 300 mm wafer) without using any physically moving parts. Such a scan is achievable without physically moving parts because no stage motion is needed during the scan. The beam from the CRT-type gun 102 is instead deflected by the electromagnetic deflection coils in a two-dimensional pattern, such as a raster pattern of a television. In other words, the stage holding the wafer may be stationary during the scanning of the wafer surface.

The signal may be taken from one (or more) of several mechanisms, including secondary electrons (SE), backscattered electrons (BSE), low-loss energy electrons, substrate current, and/or an x-ray signal. In one particular embodiment, a combination of secondary imaging and substrate imaging may provide detailed information in a novel way. In the embodiment illustrated in FIG. 1, a signal from the SE/BSE detector 108 and a signal from the substrate current monitor 110 are both fed into a video capture board 112. A processor may be configured to process the scattered electron and substrate current signals so as to map wafer properties. The wafer properties may include those other than those pertaining to contact or via holes of the wafer. Various other wafer properties may be mapped using this technique, including, for example, gate breakdown or junction leakage.

The beam current for the system of FIG. 1 may be advantageously large and in a range of one to one thousand (1 to 1000) microamperes, for example. In contrast, conventional electron beam equipment for semiconductor wafer inspection and metrology applications utilize electron beam currents in the range of a few picoamperes to a few hundred nanoamperes. This is because prior equipment use electron cathodes designed for high resolution but low current applications. These cathodes typically comprise sharp needles or hairpins of tungsten or lanthanum hexaboride. To achieve the much higher currents in a focused beam as preferred for the system of FIG. 1, it is desirable to use a different cathode structure, such as a flat disk coated with barium oxide or another low workfunction material. Such an electron source is similar to the technology used in CRTs, but such a high-current source has not to date been utilized for focused beams in semiconductor inspection or metrology.

Resolution (dependent on spot size) for the system of FIG. 1 may typically be from 10 microns to 1 millimeter, preferably at least 100 microns. A spot size greater than 0.5 microns in diameter is larger than spot sizes used in prior automated e-beam inspectors.

In an additional mode, the e-beam may have a larger spot size of about 10 millimeters, which is roughly equivalent to the size of a typical die. Depending on the beam current and averaging used, wafer scan times may range, for example, from less than a second to a few minutes.

In one embodiment, an adaptive procedure may be utilized, whereby areas of interest on the wafer are first quickly located with a very coarse beam. These smaller areas are then scanned at increasing resolutions until the desired detailed information on a particular area is obtained.

The resulting images may be post-processed to correct any minor wafer misalignment. The resulting aligned images can either be compared to known good images, or to a theoretical map. In addition, dies or regions on one wafer may be compared to other dies or regions on the same wafer.

A number of variations of the above-discussed macro e-beam inspector 100 may be implemented. For example, a grid (similar to a shadow mask in a CRT) may be placed just above the wafer to either enhance the resolution or to control the field above the wafer surface.

The above-described e-beam inspector 100 may also be extended to utilize multiple beams at low cost (due to the low cost of CRT gun technology). The use of multiple beams is advantageous in terms of increased throughput and also in maintaining a more consistent vertical landing angle across the entire wafer.

In one embodiment, the above-described e-beam inspector 100 may be advantageously integrated into another semiconductor manufacturing tool. Such integration would provide an in-situ metrology capability within the other tool. The other tool may comprise, for example, an etching type tool or a deposition type tool.

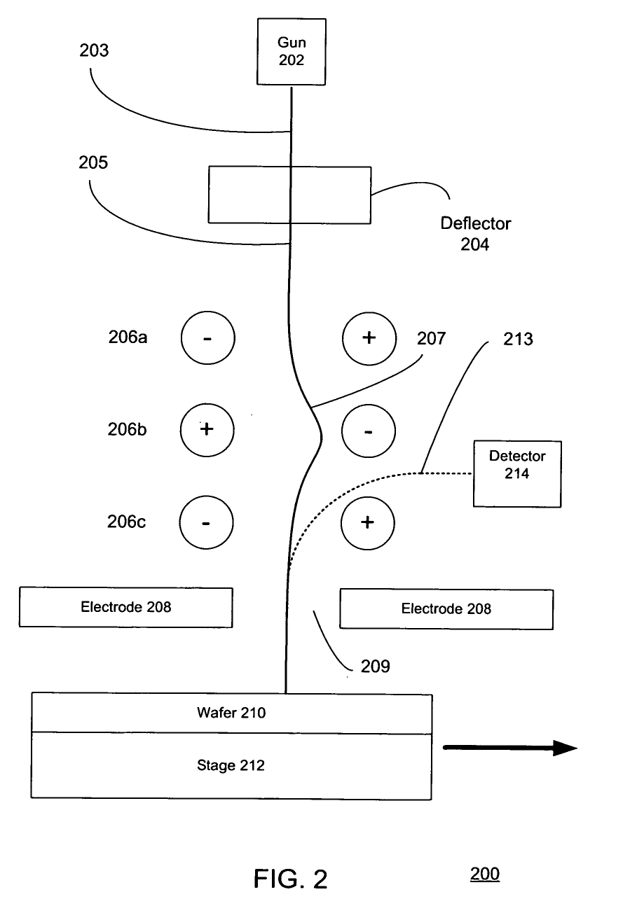

FIG. 2 is a cross-sectional schematic diagram of a first high-speed one-dimensional scanning apparatus 200 for use with a one-dimensional moving stage in accordance with a first embodiment of the invention. An electron gun 202 produces an incident electron beam 203, and a scanning deflector 204 deflects said beam in a one-dimensional scan to produce a scanned beam 205. In FIG. 2, the scanning deflector 204 deflects the beam in a dimension in-and-out of the plane of the page. The scanning deflector 204 may be implemented, for example, with a controlled electrostatic deflector. In other words, the trajectory of the scanned beam 205 is deflected such that the scanning occurs in a dimension in-and-out of the plane of the page.

In accordance with the embodiment of FIG. 2, a series of electrostatic deflectors 206 temporarily deflects 207 the scanned beam 205, but the series deflectors 206 are configured such that the temporary deflection 207 is substantially reversed by the time that the series of deflectors 206 are passed, such that the trajectory 205 prior to the series of deflectors 206 is resumed.

The apparatus 200 may be configured with an electrode 208 above the wafer 210. The electrode 208 may be configured as a plate with a slot 209 therein. The slot 209 is oriented along the scanning direction. The electrode 208 may be set at a voltage potential so as to facilitate extraction of secondary or other scattered electrons 213 from the wafer surface. The series of deflectors 206 is configured such that the extracted electrons 213 are deflected out of the path of the incident beam 205 and towards a detector 214.

The stage 212 holding the wafer 210 comprises a moving stage that translates the wafer 210 in the direction shown (to the right in the drawing). Thus, while the scanning of the wafer 210 is in the dimension in-and-out of the plane of the page, the translation of the wafer is in the horizontal direction of the figure.

In accordance with one embodiment, the electron gun 202 may comprise a CRT-type electron gun, as described herein. Moreover, to further increase the through-put of the apparatus when inspecting wafers, multiple CRT-type guns 202 and corresponding detectors 214 may be utilized. In that case, the column may be configured to deflect each electron beam so that it scans over a different segment of the wafer. In other words, the deflector system is configured to deflect each electron beam to scan across a different portion of a substrate being inspected

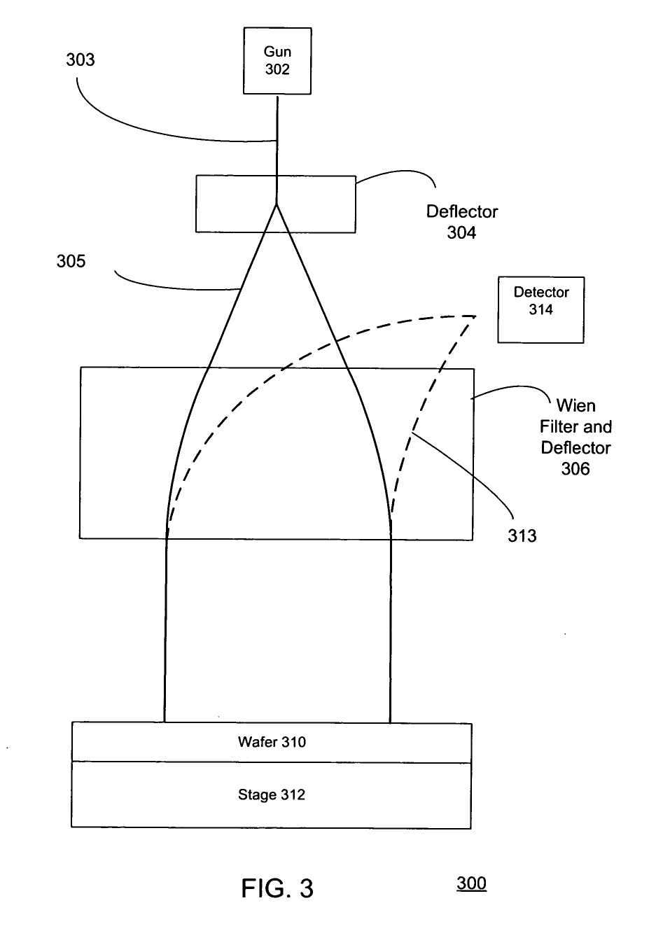

FIG. 3 is a cross-sectional schematic diagram of a second high-speed one-dimensional scanning apparatus 300 for use with a one-dimensional moving stage in accordance with an embodiment of the invention. An electron gun 302 produces an incident electron beam 303, and a scanning deflector 304 deflects said beam in a one-dimensional scan to produce a scanned beam 305. In FIG. 3, the scanning deflector 304 deflects the beam to the left and right in the figure. The scanning deflector 304 may be implemented, for example, with a controlled electrostatic deflector. In other words, the trajectory of the scanned beam 305 is deflected such that the scanning occurs in the horizontal dimension of the figure.

In accordance with the embodiment of FIG. 3, a combined Wien filter and deflector unit 306 then directs the scanned beam 305 towards the wafer 310. The Wien filter/deflector 306 is configured to produce both magnetic and electrostatic fields. Because the force caused by the magnetic field on charged-particle trajectories depends upon the velocity direction (and speed) of the charged-particles, the Wien filter/deflector 306 has a different effect on electrons in the incident beam 305 than on secondary or scattered electrons 313. The Wien filter/deflector 306 may be advantageously configured so as to deflect the scattered electron beam 313 towards a detector 314.

The apparatus 300 may also be configured with an electrode (not depicted) above the wafer 310. The electrode may be configured as a plate with a slot therein. The slot is oriented along the scanning direction. The electrode may be set at a voltage potential so as to facilitate extraction of secondary or other scattered electrons 313 from the wafer surface.

The stage 312 holding the wafer 310 comprises a moving stage that translates the wafer 310 in a direction perpendicular to the scanning direction. Thus, while the scanning of the wafer 310 is in the horizontal dimension of the figure, the translation of the wafer is in the direction in or out of the plane of the page.

In accordance with one embodiment, the electron gun 302 may comprise a CRT-type electron gun, as described herein. Moreover, to further increase the through-put of the apparatus when inspecting wafers, multiple CRT-type guns 302 and corresponding detectors 314 may be utilized. In that case, the column may be configured to deflect each electron beam so that it scans over a different segment of the wafer. In other words, the deflector system is configured to deflect each electron beam to scan across a different portion of a substrate being inspected

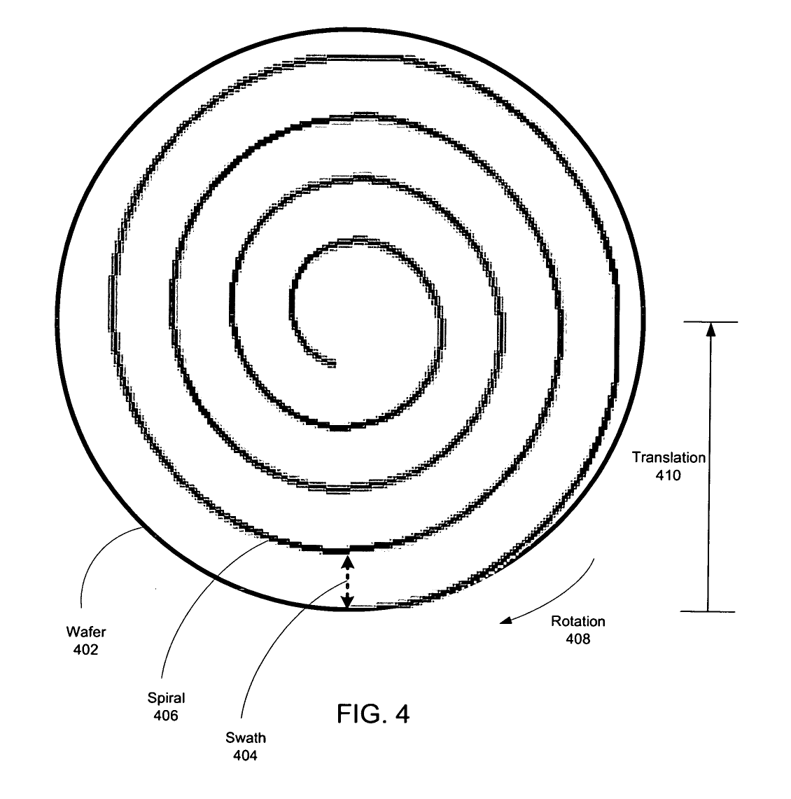

FIG. 4 is a schematic diagram of a high-speed swath scan of a wafer 402 using a spiral path 406 in accordance with an embodiment of the invention. In accordance with this embodiment, the apparatus may comprise a more conventional electron beam column, but the stage comprises a spiral-motion (r-θ) stage to facilitate the rapid scanning.

The incident electron beam is scanned along a swath 404. The length of the swath 404 is preferably just a fraction of the radius of the wafer. While the scanning is confined to a relatively small swath 404, the desired area of the wafer 402 is covered by simultaneous rotational 408 and translational 410 motion of the stage holding the wafer 402. The spot size for the incident beam may typically be 0.5 microns or larger.

In the example shown in FIG. 4, the rotation 408 is clockwise and the simultaneous translation 410 is in the up direction in the page. In this way, the spiral path 406 illustrated in FIG. 4 is achieved, and substantially all or all of the wafer surface may be rapidly inspected. While FIG. 4 shows the spiral going from the outer circumference of the wafer towards the center of the wafer, an alternate embodiment may achieve a path going from the center of the wafer towards the outer circumference.

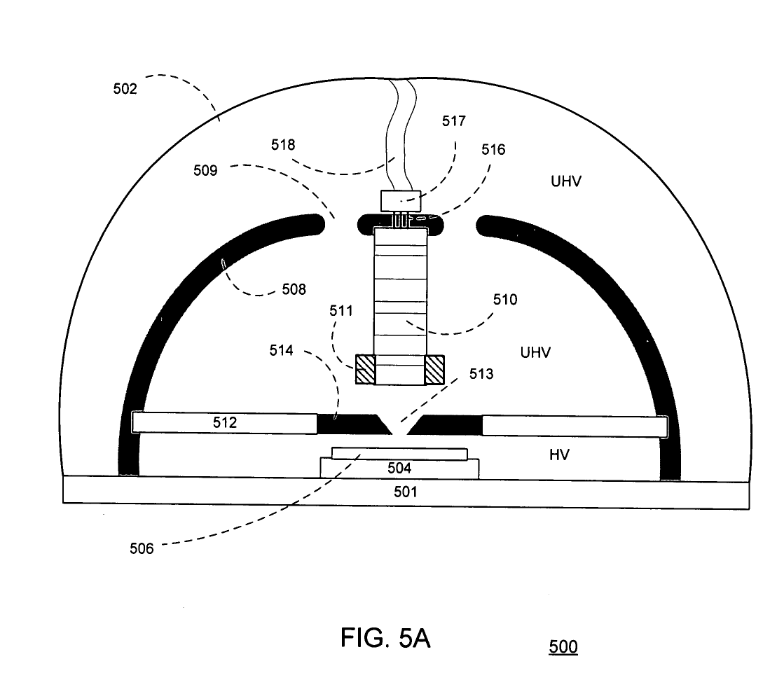

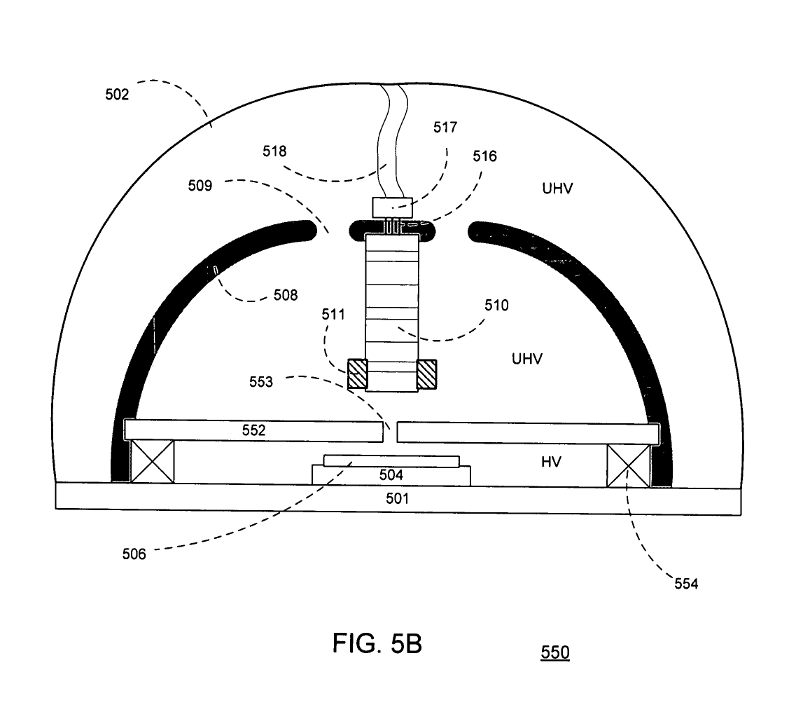

FIG. 5A is a schematic diagram of a low-vibration two-dimensional scanning apparatus 500 in accordance with an embodiment of the invention. The diagram shows a cross-sectional view of the apparatus 500.

The apparatus 500 includes a main vacuum chamber. The main vacuum chamber may comprise a base plate 501 on top of which may be configured a bell jar 502. Various valves (not shown) may be included and used for vacuum pumping of the chamber, inserting a specimen into the vacuum chamber, and other functions.

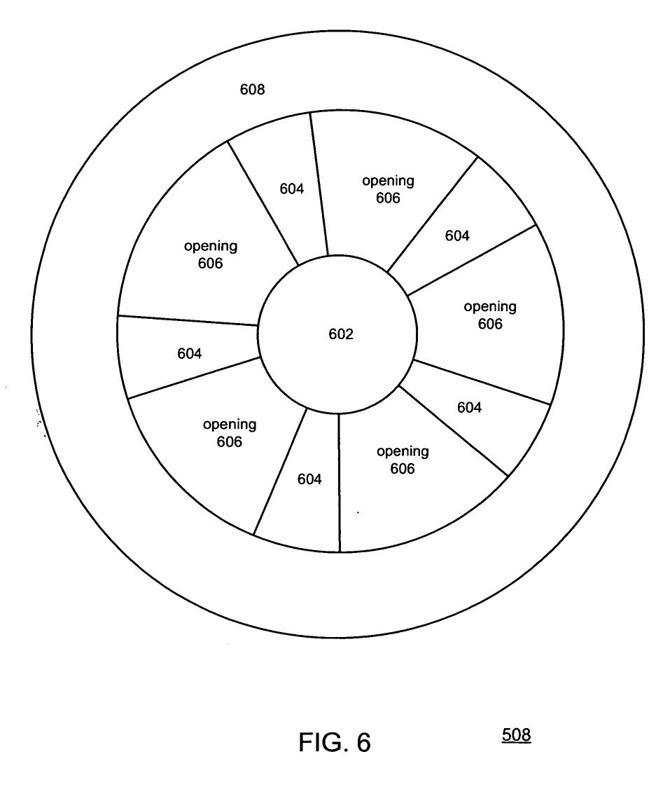

A movable stage 504 is shown which holds a substrate specimen 506 being examined or processed. In one example, the substrate specimen 506 may comprise a semiconductor wafer being manufactured. A strong and light-weight support structure 508 may be configured within the main vacuum chamber. The support structure 508 is constructed out of a vacuum-compatible material such as titanium or aluminum. The support structure 508 includes openings 509 so that an ultra high vacuum (UHV) level may be maintained both inside and outside of the structure 508. An UHV level may be defined as pressure on the order of 10⁻⁹ Torr or less. A top view of an example support structure 508 is shown in FIG. 6 and discussed below in relation thereto.

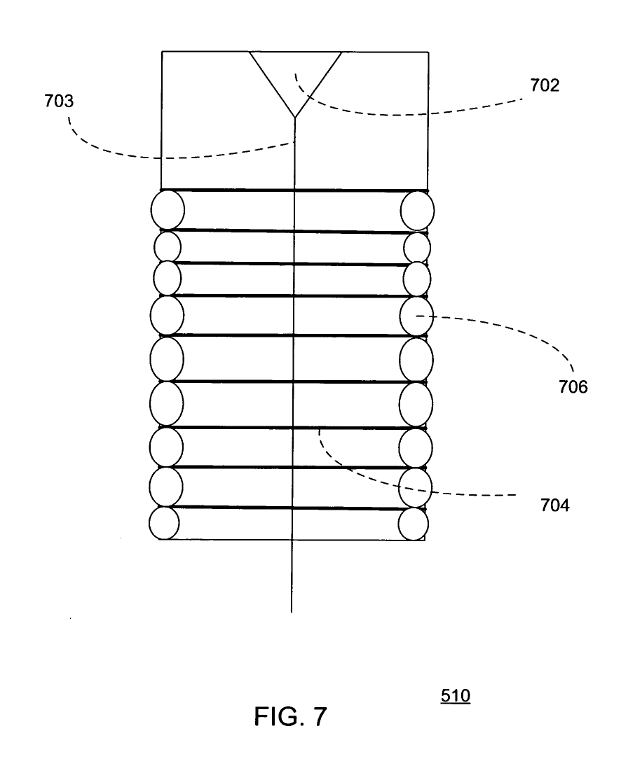

A CRT-type e-beam column 510 may be coupled to the support structure 508. The column 510 is configured similarly as a “neck” portion of a CRT tube. However, unlike a CRT tube for a television which is configured for magnification, the CRT-type e-beam column 510 is configured for de-magnification. This de-magnification may be achieved by applying appropriate voltages onto conductive plates within the column 510. An example of such a column 510 is shown in further detail in FIG. 7 and discussed below in relation thereto.

Attached to the CRT-type column 510 may be controllable deflection coils 511. The controllable deflection coils 511 may be in the form of a deflection yoke and are preferably configured so as to be able to controllably deflect the electron beam from the CRT-type column 510 in a two-dimensional pattern over the surface of the substrate specimen 506.

Inside the support structure 508 may be configured a plate 512 which separates the UHV in which the column 510 is maintained from the high vacuum (HV) in which the substrate specimen 506 resides. A HV level may be defined as having pressure on the order of 10⁻⁶ Torr or less. An opening 513 in the plate allows the electron beam to travel from the column 510 to the substrate 506. The opening 513 further may function as a vacuum pumping differential aperture between the HV level for the substrate 506 and the UHV level for the column 510.

In accordance with this embodiment, an inner portion 514 of the plate 512 may comprise a permanent magnet made out of magnetic material and may be configured to function as an objective lens. This objective lens 514 may be configured to focus the electron beam from the column 510 onto the surface of the substrate 506.

Electrical leads 516 from the CRT-type column 510 may be coupled to a connector 517 to cabling 518 leading outside of the main vacuum chamber. Voltages may be applied to the electron source and conductive plates within the column 510 by way of this cabling 518. Advantageously, the CRT-type column 510 may be easily replaceable by removing an old column 510 and plugging in a new column 510.

FIG. 5B is a schematic diagram of a low-vibration two-dimensional scanning apparatus 550 in accordance with another embodiment of the invention. This apparatus 550 is similar to the apparatus 500 of FIG. 5A. However, in the apparatus 550 of FIG. 5B, the plate 552 with the opening 553 for the e-beam does not include a permanently magnetized portion and so does not incorporate the objective lens. Instead, electromagnets 554 are configured to provide the objective lens functionality of focusing the beam onto the surface of the substrate 506. In an alternate embodiment (not illustrated), the objective lens may be implemented by an electrostatic lens.

FIG. 6 is a top-view diagram of a support structure 508 of the low-vibration two-dimensional scanning apparatus in accordance with an embodiment of the invention. The support structure 508 has an outer portion 608 which couples to the base plate 501 and rises to a height above the base plate 501. On the top (inner) portion, there are support sections 604 separated by openings 606. The openings 606 enable the UHV vacuum level to be pumped through the support structure 508. A center portion 602 is supported by the support sections 604. The CRT-type column 510 is coupled to and supported by this center portion 602 of the support structure 508.

FIG. 7 is a schematic diagram of a CRT-type e-beam column 510 in accordance with an embodiment of the invention. A cross-sectional view of the column 510 is shown. As mentioned above, this column 510 has some similarities to a “neck” of a CRT for a television. The “open” structure of the column 510 allows for the column 510 to be evacuated to the UHV level surrounding it within the bell jar 502.

An electron source 702 is configured at one end of the column 510. Preferably, the source 702 comprises a field emitter tip. The field emitter tip may comprise, for example, a thermal (Schottky) field emitter, a dispenser (i.e. a Barium-Tungsten matrix cathode), or a cold field emitter.

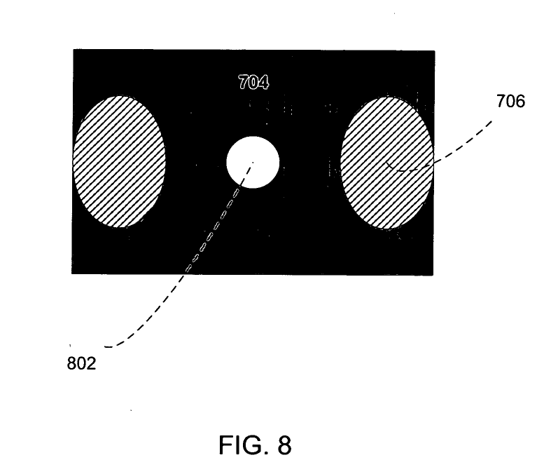

The column 510 comprises conductive plates 704 separated by insulative material 706. The insulative material 706 preferably comprises fused beaded glass. The column 510 manipulates the electron beam 703 using electrostatic electron optics by applying voltages to the conductive plates 704. The beam of electrons 703 from the source 702 is transmitted through holes (see FIG. 8) in a center portion of the plates 704. The plates 704 may be implemented using Nickel or another metal. The plates 704 may comprise stamped parts, or they may be manufactured by automated arc cutting. Such easily manufactured parts advantageously enables statistical process control to be applied so as to efficient make the parts.

FIG. 8 is a schematic diagram of a conductive plate 704 within the CRT-type e-beam column 510 in accordance with an embodiment of the invention. A top view of the plate 704 is shown. The plate 704 is shown in rectangular shape, but may be in other shapes. The hole 802 for the e-beam transmission is shown in the center of the plate 704. Fused glass beads 706 are shown as lying on top of the plate 704 and are used to mechanically connect the plate 704 to the other plates 704. The beads 706 also serve to electrically insulate the plates 704 from each other.

The CRT-type e-beam gun or column may be configured and manufactured in various ways other than the ways discussed above in relation to FIGS. 7 and 8. Various patent publications discuss such various CRT-type gun configurations and manufacturing techniques. The following table includes a listing of several such patent publications relating to CRT-type gun configurations and manufacturing techniques. All of the below-listed patents are hereby incorporated by reference.

| U.S. Pat. | | |
|---|---|---|
| No. | Applicant | Title |
| 3,749,708 | Schweitzer | Process for Controlling Cathode Ray Tube |
| | et al. | Cutoff Voltage by Cathode Insertion with |
| | | Accelerating Grid Compensation |
| 4,204,302 | Bing et al. | Method for Terminating an Electrical |
| | | Resistor for a Television CRT |
| 4,720,654 | Hernqvist | Modular Electron Gun for a Cathode-Ray |
| | et al. | Tube and Method of Making Same |
| 5,295,887 | Zdanowski | K-G1 Electrode Spacing System for a CRT |
| | | Electron Gun |
| 5,430,350 | Chen et al. | Electron Gun Support and Positioning |
| | | Arrangement in a CRT |
| 5,521,462 | Muchi et | Electron Gun for CRT |
| | al. | |
| 5,857,887 | Gotoh | Method of Manufacturing a Cathode-Ray Tube |
| 5,869,924 | Kim | Cathode Structure and CRT Electron Gun |
| | | Adopting the Same |
| 6,031,326 | Suzuki et | Electron Gun with Electrode Supports |
| | al. | |
| 6,445,116 | Uchida et | Color Cathode Ray Tube Having an Improved |
| | al. | Electron Gun |
| 6,456,017 | Bae et al. | Electron Gun for Cathode Ray Tube |
| 6,577,052 | Suzuki et | Electron Gun for Cathode Ray Tube |
| | al. | |
| 6,580,210 | Houben et | Method of Manufacturing an Electron Gun, |
| | al. | Electron Gun Display Device with Such an |
| | | Electron Gun, and Sub-Assembly for Use in |
| | | Such an Electron Gun |
| 6,744,193 | Kim et al. | Funnel Structure for Cathode Ray Tube |
| 6,750,601 | Kim | Electron Gun for Color Cathode Ray Tube |
| 6,771,015 | Lee | Electron Gun for Cathode Ray Tube |
| 6,794,807 | Oh et al. | Electron Gun for Cathode Ray Tube |
| 6,800,991 | Choi | Cathode Ray Tube |
| 6,840,834 | Schueller | Package Structure for Mounting a Field |
| | et al. | Emitting Device in an Electron Gun |
| 6,952,077 | Park et al. | Electron Gun for Cathode Ray Tube |

There are various inventive aspects of embodiments of the invention. For example, one aspect relates to the use of a CRT-type column 510 for an automated e-beam inspection, review or metrology tool. In other words, the e-beam column of the automated tool comprises CRT-type components. In contrast, conventional e-beam columns for electron microscopes and automated e-beam inspection/review/metrology apparatus are made using bulky components, typically including gun lenses, condenser lenses, and the like.

Another aspect relates to manufacturing an electron microscope column using CRT-type manufacturing techniques. For example, the CRT-type column 510 for the electron microscope or automated e-beam inspection/review/metrology apparatus may be manufactured by techniques including fusing beaded glass and arc cutting. Stamped parts may be utilized, and the manufacturing process may involve statistical process control.

In another aspect, the CRT-type column may be easily replaceable by “plugging in” a new CRT-type column. This reduces cost and time required to maintain the apparatus.

In another aspect, the optics of the CRT-type column may comprise all electrostatic optics. In another aspect, the optics of the CRT-type column may comprise CRT-type electrostatic optics combined with a magnetic objective lens (see FIGS. 5A and 5B). The objective lens may be implemented with permanent magnets (FIG. 5A). Alternatively, the objective lens may be implemented with an electromagnetic objective lens (FIG. 5B).

Applications of the above-discussed high-speed e-beam inspection include, but are not limited to, determinations of contact or via etch uniformity, contact or via size, gate oxide leakage, gate oxide breakdown, junction leakage, field oxide quality or uniformity, interlayer dielectric (ILD) quality or uniformity, chemical mechanical planarization (CMP) thickness uniformity, and resist process uniformity. The high-speed inspection may also be applied to detection of large particles, or scratches, or missing patterns. More generally, the apparatus described above may be utilized for e-beam lithography, inspection, review or metrology. In another application, the CRT-type column may be utilized as an electron beam flood gun which may be used, for example, to pretreat photoresist.

In one possible embodiment, multiple CRT-type upper columns may be used in combination with a single electromagnetic objective lens. Another possible embodiment relates to parallel imaging using multiple miniature columns made using CRT-type optics.

Portable SEM

The large bulk of a conventional scanning electron microscope (SEM) makes it costly to manufacture and also limits its practical applications. In order to examine an object of interest by a conventional SEM, the object must typically be sampled, and the sample prepared so as to be suitable for placing into the SEM sample holder. The SEM is typically stationary in a laboratory setting.

The present disclosure provides a new and inventive design for a portable SEM. The portable SEM may be readily transported by a single person to the location of the object of interest. In one embodiment, a sample of the object of interest may be inserted into a rapid access specimen holder of the portable SEM. In another embodiment, the portable SEM may be placed in direct contact with a bulk object of interest using an environmental interface, such that no sampling may be required to examine the object surface.

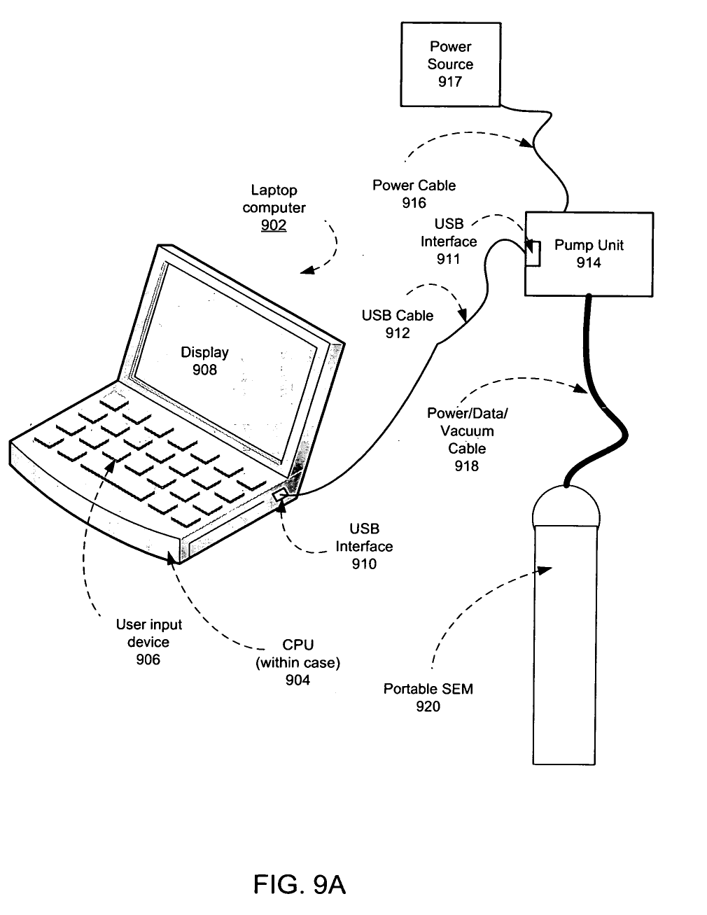

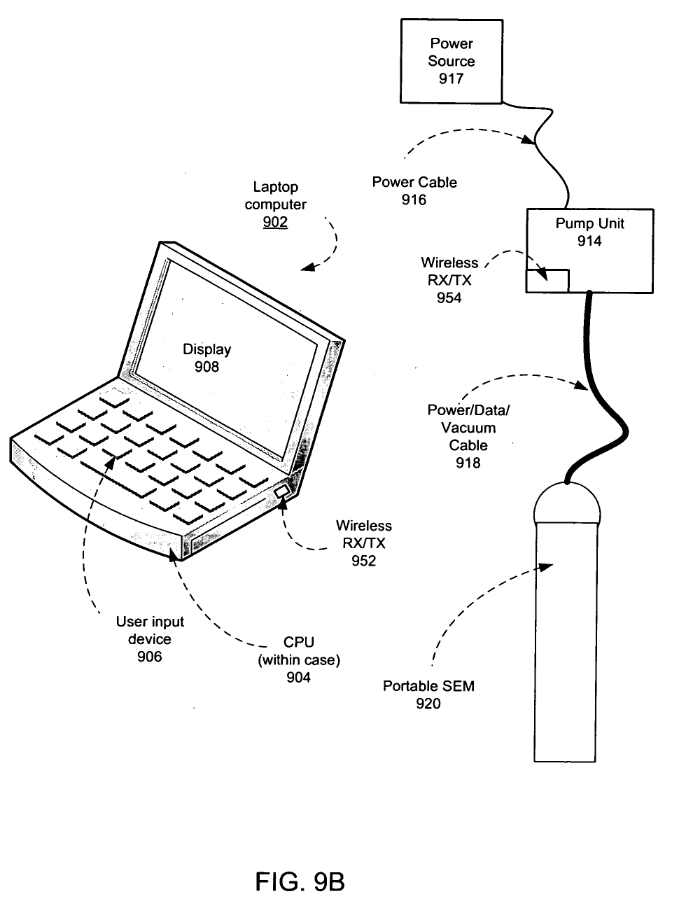

FIG. 9A is a schematic diagram of a portable SEM system with a wired data interface in accordance with an embodiment of the invention. The portable SEM system may be implemented so as to have a total weight of about 30 pounds or less so as to be transportable by a single person.

The system includes a portable laptop or other portable computer 902 to display and store the images from the SEM and to control the SEM. The computer 902 includes, among other components, a central processing unit (within its case) 904, a user input device (such as a keyboard and mouse or other pointing device) 906, and a display (such as an LCD display panel) 908.

In accordance with this embodiment, the computer 902 also includes a universal serial bus (USB) interface or other data interface 910. This data interface 910 is connected to a corresponding data interface 911 for the portable SEM via a USB cable or other appropriate data cable 912. In FIG. 9A, the data interface 911 is shown to be located at and integrated with the pump unit 914 attached to the portable SEM device 920. In a less convenient alternate configuration, the data interface 911 may be located at and integrated with the portable SEM device 920.

The pump unit 914 may comprise, for example, a single stage membrane type pump which is portable and is configured to serve as a vacuum pump for the portable SEM 920. The pump unit 914 may be powered, for example, by 110 volt AC power from a wall outlet. Alternatively, for further portability, the pum unit 914 may be battery powered. A power/data/vacuum cable 918 may connect from the pump unit 914 to the portable SEM device 920. The cable 918 provides power and control signals to the portable SEM device 920. The cable 918 also provides the vacuum suction from the pump unit 914 to the portable SEM device 920. Data, including electron image frames, may be output from the portable SEM device 920 via the data cable 912 to the laptop computer 902.

FIG. 9B is a schematic diagram of a portable SEM system with a wireless data interface in accordance with an embodiment of the invention. The portable SEM system may be implemented so as to have a total weight of about 30 pounds or less so as to be transportable by a single person.

The system includes a portable laptop or other portable computer 902 to display and store the images from the SEM and to control the SEM. The computer 902 includes, among other components, a central processing unit (within its case) 904, a user input device (such as a keyboard and mouse or other pointing device) 906, and a display (such as an LCD display panel) 908.

In accordance with this embodiment, the computer 902 also includes a wireless receiver/transmitter (RX/TX) 952, such as one compatible with the 802.11 standards or a Bluetooth standard. This wireless RX/TX 952 communicates via a wireless link with a corresponding wireless RX/TX 955 for the portable SEM. In FIG. 9B, the corresponding wireless RX/TX 955 is shown to be located at and integrated with the pump unit 914 attached to the portable SEM device 920. In an alternate configuration, the corresponding wireless RX/TX 955 may be located at and integrated with the portable SEM device 920.

The pump unit 914 may comprise, for example, a single stage membrane type pump which is portable and is configured to serve as a vacuum pump for the portable SEM 920. The pump unit 914 may be powered, for example, by 110 volt AC power from a wall outlet. Alternatively, for further portability, the pum unit 914 may be battery powered. A power/data/vacuum cable 918 may connect from the pump unit 914 to the portable SEM device 920. The cable 918 provides power and control signals to the portable SEM device 920. The cable 918 also provides the vacuum suction from the pump unit 914 to the portable SEM device 920. Data, including electron image frames, may be output from the portable SEM device 920 via the wireless link to the laptop computer 902.

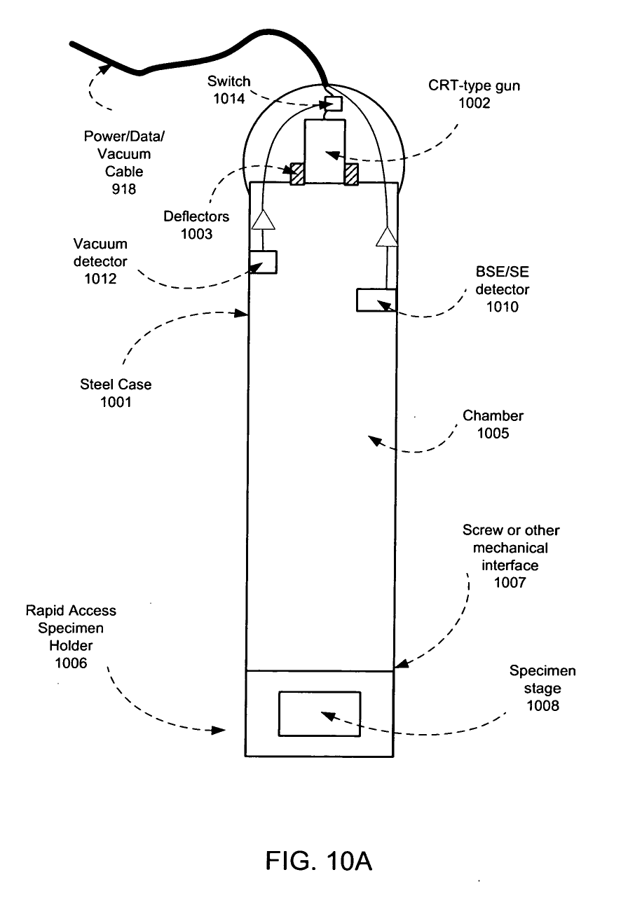

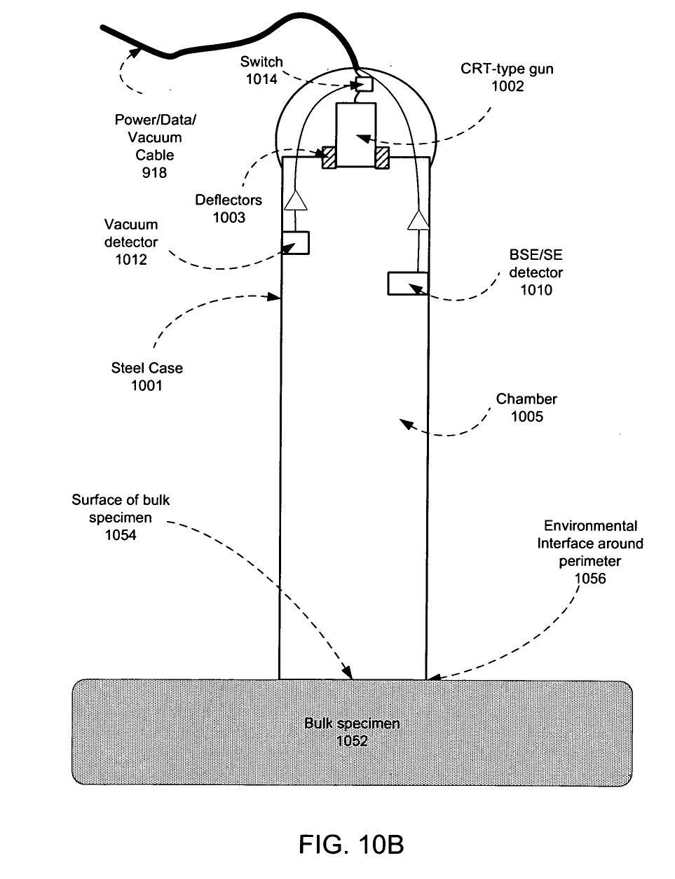

FIG. 10A is a schematic diagram of a portable SEM device 920 with a rapid access specimen holder 1006 in accordance with an embodiment of the invention. As discussed in relation to the system diagrams, the portable SEM device 920 may be configured to receive power, vacuum pumping and data communication via the power/data/vacuum cable 918.

The portable SEM device 920 may be enclosed with a steel or similar case 1001 to reduce radiation which may be generated by the electron beam. A CRT-type gun 1002 may be utilized to generate the electron beam. As discussed in detail above, the CRT-type gun 1002 may be constructed using multiple metal plates separated by insulative material. Advantageously, the CRT-type gun 1002 is much smaller and lighter in weight than an electron beam gun and column used in conventional SEM devices.

In one implementation, the CRT-type gun 1002 may be evacuated and maintained in high vacuum (in a range of about 10⁻⁵ to 10⁻⁸ Torr) by the pump provided by the power/data/vacuum cable 918. In an alternate implementation, the CRT-type gun 1002 may be in a sealed vacuum. In that case, the beam may be transmitted through an electron beam transparent window from the CRT-type gun 1002 to the main chamber 1005 of the portable SEM device 920. For example, the window may be made out of diamond or another electron-beam-transparent material. The window serves to maintain the sealed vacuum while allow transmission of the electron beam. In addition, a getter material may be included within the sealed vacuum of the CRT-type gun 1002 so as to facilitate its operation in vacuum.

Deflectors (which may be in the form of an electromagnetic deflection yoke) 1003 may be attached to or configured in the vicinity of the CRT-type gun 1002. These deflectors 1003 may be utilized to controllably scan the electron beam across a two-dimensional area of the sample being examined.

The scanned beam is transmitted through the chamber 1005 of the portable SEM device 920. The chamber 1005 may be evacuated and held in vacuum by the vacuum pump provided by the power/data/vacuum cable 918. The level of vacuum in the chamber 1005 may be an “environmental” vacuum level in a range of about 10⁻⁴ to 10⁻¹ Torr.

In this embodiment, the specimen being scanned may be held on a specimen stage 1008 of a rapid access specimen holder 1006. The holder 1006 may be rapidly removed from and rapidly attached to the chamber 1005. For example, a screw, clamp, or other mechanical interface 1007 may be utilized for the attachment/removal of the holder 1006 to/from the chamber 1005. When the holder 1006 is attached to the chamber 1005, the volume of the holder 1006 is also evacuated and held in vacuum.

Backscattered and/or secondary electrons are caused by impingement of the scanned electron beam onto the specimen surface. The backscattered and/or secondary electrons may be detected using an electron detector 1010 configured within the chamber 1005. The detected signals may be processed by circuitry and transmitted back to the laptop via the power/data/vacuum cable 918. Alternatively, or in addition, an x-ray detector may be included for x-ray analysis of the material being scanned.

For purposes of safety and longevity of operation, a vacuum detector 1012 may be included in the chamber 1005. If no or insufficient vacuum is detected, then a safety switch 1014 may cut off power to the CRT-type gun 1002.

FIG. 10B is a schematic diagram of a portable SEM device 920 with an environmental interface 1056 in accordance with an embodiment of the invention. As discussed in relation to the system diagrams, the portable SEM device 920 may be configured to receive power, vacuum pumping and data communication via the power/data/vacuum cable 918.

The portable SEM device 920 may be enclosed with a steel or similar case 1001 to reduce radiation which may be generated by the electron beam. A CRT-type gun 1002 may be utilized to generate the electron beam. As discussed in detail above, the CRT-type gun 1002 may be constructed using multiple metal plates separated by insulative material. Advantageously, the CRT-type gun 1002 is much smaller and lighter in weight than an electron beam gun and column used in conventional SEM devices.

In one implementation, the CRT-type gun 1002 may be evacuated and maintained in a high vacuum (in a range of about 10⁻⁵ to 10⁻⁸ Torr) by the pump provided by the power/data/vacuum cable 918. In an alternate implementation, the CRT-type gun 1002 may be in a sealed vacuum. In that case, the beam may be transmitted through an electron beam transparent window from the CRT-type gun 1002 to the main chamber 1005 of the portable SEM device 920. For example, the window may be made out of diamond or another electron-beam-transparent material. The window serves to maintain the sealed vacuum while allow transmission of the electron beam. In addition, a getter material may be included within the sealed vacuum of the CRT-type gun 1002 so as to facilitate its operation in vacuum.

Deflectors (which may be in the form of an electromagnetic deflection yoke) 1003 may be attached to or configured in the vicinity of the CRT-type gun 1002. These deflectors 1003 may be utilized to controllably scan the electron beam across a two-dimensional area of the sample being examined.

The scanned beam is transmitted through the chamber 1005 of the portable SEM device 920. The chamber 1005 may be evacuated and held in vacuum by the vacuum pump provided by the power/data/vacuum cable 918. The level of vacuum in the chamber 1005 may be an “environmental” vacuum level in a range of about 10⁻⁴ to 10⁻¹ Torr.

In accordance with this embodiment, the specimen being scanned may be a bulk specimen 1052. For example, the bulk specimen 1052 may comprise a wing or other part of an aircraft being inspected for mechanical defects. Advantageously, the portable SEM device 920 may be brought to the location of the bulk specimen.

As shown in FIG. 10B, the portable SEM device 920 may include an environmental interface 1056. In one implementation, the environmental interface 1056 may create a mechanical seal around the perimeter of the cross-section which is placed in contact with the bulk specimen 1052. Such a mechanical seal allows the chamber 1005 to be vacuum pumped. In another implementation, the environmental interface 1056 may create an air seal around the perimeter of the cross-section which is placed in contact with the bulk specimen 1052. Such an air seal blows air out of the perimeter so as to create a cushion of air on top of which the portable SEM device 920 may float. In addition, such an air seal also allows the chamber 1005 to be vacuum pumped.

Backscattered and/or secondary electrons are caused by impingement of the scanned electron beam onto the specimen surface 1054. The backscattered and/or secondary electrons may be detected using an electron detector 1010 configured within the chamber 1005. The detected signals may be processed by circuitry and transmitted back to the laptop via the power/data/vacuum cable 918. Alternatively, or in addition, an x-ray detector may be included for x-ray analysis of the material being scanned.

For purposes of safety and longevity of operation, a vacuum detector 1012 may be included in the chamber 1005. If no or insufficient vacuum is detected, then a safety switch 1014 may cut off power to the CRT-type gun 1002.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An apparatus which utilizes an electron beam for inspection or metrology of a substrate, the apparatus comprising a CRT-type gun and deflectors to generate and scan the electron beam.

2. The apparatus of claim 1, wherein the CRT-type gun comprises metal plates supported by and separated by insulating material.

3. The apparatus of claim 2, wherein the insulating material comprises fused glass beads.

4. The apparatus of claim 1, wherein the apparatus further comprises a magnetic objective lens.

5. The apparatus of claim 1, wherein the CRT-type gun is plugged into the apparatus so as to be readily replaceable by plugging in a new column.

6. The apparatus of claim 1, further comprising a gate valve to separate the CRT-type gun from a vacuum chamber into which the substrate is loaded.

7. The apparatus of claim 1, wherein the CRT-type gun is in a sealed vacuum, and wherein the CRT-type gun emits the electron beam through an electron-beam-transparent window.

8. An apparatus which utilizes an electron beam for inspection or metrology of a substrate, the apparatus comprising
a vacuum chamber including a base plate;
a support structure connected to the base plate; and
a column including an electron source and a series of electron lenses,
wherein the electron lenses comprise metal plates mechanically supported by and separated by insulating material.

9. The apparatus of claim 8, wherein the insulating material comprises fused glass beads.

10. The apparatus of claim 8, wherein the column is mechanically supported by a top portion thereof connected to the support structure.

11. A method of inspecting a substrate or measuring an aspect of the substrate, the method comprising focusing an electron beam using electrostatic lenses formed by an arrangement of metal plates supported by and separated by insulative material such that the spacing between the metal plates is fixed.

12. The method of claim 11, wherein the insulative material comprises fused glass beads.

13. The method of claim 11, wherein the electron beam is further focused by a magnetic objective lens.

14. The method of claim 11, wherein the arrangement of metal plates is in a sealed vacuum, and wherein the electron beam is transmitted through an electron-beam-transparent window.

15. A method of manufacturing an electron beam column for an electron microscope, the method comprising using insulative material to separate a series of metal plates by fixed distances.

16. The method of claim 15, wherein the insulative material comprises fused glass beads.

17. The method of claim 15, wherein the metal plates comprise stamped metal parts.

18. The method of claim 15, wherein the metal plates comprise arc-cut metal parts.

19. A scanning electron microscope apparatus having an electron gun lens assembly, wherein the gun lens assembly comprises at least three separate metal plates forming a gun lens and at least two insulators fixing positions of the metal plates with respect to each other.

20. The scanning electron microscope apparatus of claim 19, wherein the insulators comprise fused glass beading.

21. The scanning electron microscope apparatus of claim 19, wherein the gun lens assembly is in a sealed vacuum, and wherein the gun lens assembly transmits an electron beam through an electron-beam-transparent window towards a substrate being scanned.

22. A scanning electron microscope apparatus having multiple electron gun lens assemblies, wherein each gun lens assembly comprises at least three separate metal plates forming a gun lens and at least two insulators fixing positions of the metal plates with respect to each other.

23. The apparatus of claim 22, wherein an electron beam is generated from each of the multiple gun lens assemblies, and wherein a deflector system is configured to deflect each electron beam to scan across a different portion of a substrate being inspected.
